(19) United States
(12) Patent Application Publication
(10) Pub. No.: US 2007/0215686 A1
(43) Pub. Date: Sep. 20, 2007

(54) Automated teller machine voice guidance system and method

(76) Inventors: Craig E. Matson, Floral Park, NY (US); Arthur Barnett, New York, NY (US); Jaromir G. Divilek, Bronx, NY (US)

Correspondence Address: FITZPATRICK CELLA (AMEX), 30 ROCKEFELLER PLAZA, NEW YORK, NY, 10112, US

(21) Appl. No.: 10/764,171

(22) Filed: Jan. 22, 2004

(51) Int. Cl. G07F 19/00; G06F 7/08

(52) U.S. Cl. 235/379; 235/381

(57) ABSTRACT

There is provided an automated teller machine (ATM) voice guidance system and method that enables a visually and/or hearing impaired individual to conveniently and easily carry out financial transactions on an ATM to thereby conform to government regulations. The ATM voice guidance system provides simultaneous and synchronized audio instructions via an audio port that correspond to visual instructions presented on an ATM display screen and comprises creating voice guidance instructions and scripts, converting the instructions and scripts to audio files, loading the audio files to an ATM for subsequent access and retrieval of the audio files for voice guidance, detecting use of the ATM, outputting the selected audio files to an audio port in synchronization with said corresponding text instructions or scripts displayed on a display screen, and accepting user input to said outputted audio files.

### TECHNICAL FIELD

The present subject matter relates generally to the field of automated teller machines. More particularly, the present subject matter relates to the use and operation of automated teller machines by the visually and hearing impaired.

### BACKGROUND

Automated teller machines (ATMs) are well known devices typically used by individuals to carry out a variety of personal and business financial transactions and/or banking functions. ATMs have become very popular with the general public for their availability and general user friendliness. ATMs are now found in many location having a regular or high volume of consumer traffic. For example, ATMs are typically found in restaurants, supermarkets, convenience stores, malls, schools, gas stations, hotels, work locations, banking centers, airports, entertainment establishments, transportation facilities and a myriad of other locations. ATMs are typically available to consumers on a continuous basis such that consumers have the ability to carryout their ATM financial transactions and/or banking functions at any time of the day and on any day of the week.

Existing ATMs are convenient and easy to use for most consumers. Existing ATMs typically provide instructions on an ATM display screen that are read by a user to provide for interactive operation of the ATM. Having read the display screen instructions, a user is able to use and operate the ATM via data and information entered on a keypad. However, existing ATMs present problems and difficulties for users with visual impairments.

There is therefore a need for an ATM which can be more easily used by individuals that are visually impaired.

### SUMMARY

The present subject matter provides an automated teller machine (ATM) voice guidance system that enables a visually and/or hearing impaired individual to conveniently and easily carry out financial transactions or banking functions. The system comprises a card reader for reading and translating card information from a card; a presenting screen for displaying information and operating instructions to a user; an audio port for providing audible messages and instructions in synchronization with corresponding information and operating instructions displayed on the display screen; a keypad for receiving user input to enable operation of the ATM in response to the audible messages and/or operating instructions displayed on the screen; a data storage medium adapted for storage of data relating to audio signals and text representations of instructions and scripts for using and operating the ATM; and a processor connected to the card reader, audio port, display screen, keypad, and the data storage. The processor is adapted to detect initiation of use of the ATM by the user to automatically access and retrieve selected audio files and corresponding text representations of instructions and scripts from the data storage medium, and to simultaneously output the selected audio files to the audio port in synchronization with the display of the corresponding text instructions and scripts on the display screen. The system may also include a currency dispenser for dispensing a specified amount of currency; a transaction receipt means for outputting a transaction record; and a deposit slot.

There is also provided a method for operating an ATM voice guidance system including the steps of creating voice guidance instructions and scripts; converting the instructions and scripts to “.wav” audio files using a conversion software application; loading the “.wav” audio files to an ATM for subsequent access and retrieval of the “.wav” audio files for voice guidance; detecting a customer initiating operation of the ATM; automatically accessing and retrieving selected “.wav” audio files and corresponding text instructions or scripts; outputting the selected “.wav” audio files via an audio port in synchronization with the corresponding text instructions or scripts displayed on a display screen; and receiving the “.wav” audio files via a speaker or a user headphone set.

It is an objective to provide an ATM voice guidance system to enable a visually or hearing impaired customer to use and operate an ATM to conduct a financial transaction.

It is also an objective to provide an ATM voice guidance system that simultaneously outputs specific audio files to a headset via an audio port in synchronization with the display of the corresponding text instructions and scripts on the ATM display screen.

Additional objects, advantages and novel features of the examples will be set forth in part in the description which follows, and in part will become apparent to those of ordinary skill in the art upon examination of the following and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements. The description may be better understood when read in connection with the accompanying drawings, of which:

FIG. 1 illustrates a flow chart of a method for implementing an ATM voice guidance system; and

FIG. 2 illustrates a schematic diagram of an ATM voice guidance system.

### DETAILED DESCRIPTION

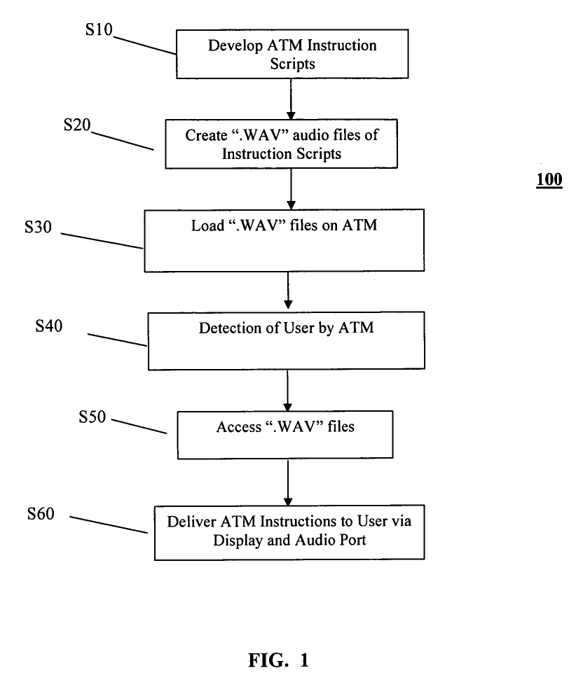

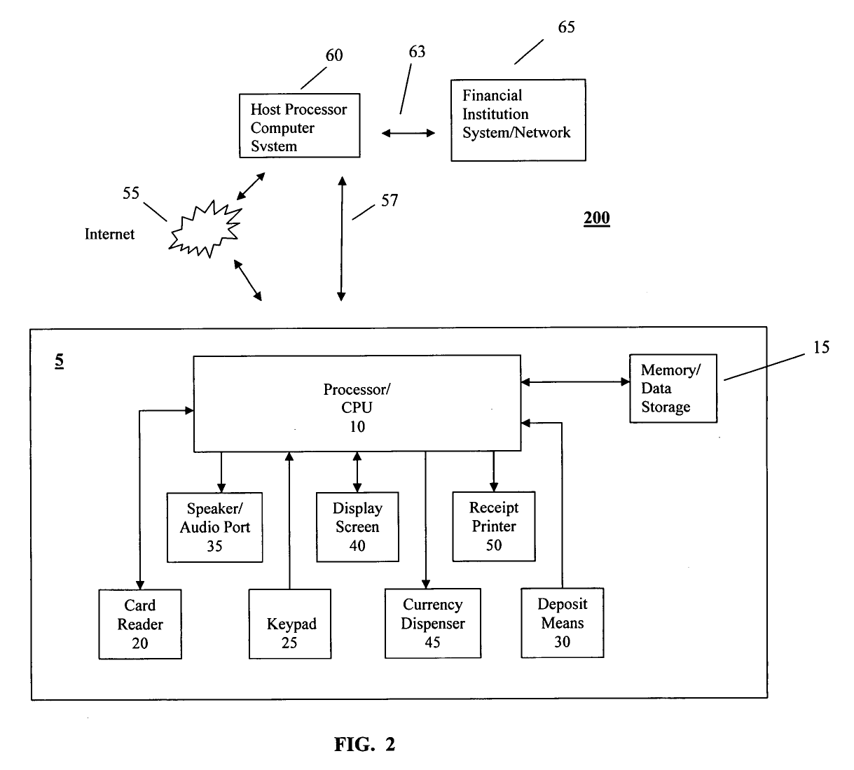

FIG. 1 is a flow chart showing the steps of implementing an automated teller machine (ATM) voice guidance system 100. The ATM voice guidance system 100 provides a convenient and easy means for the visually and/or hearing impaired to interactively use and operate an ATM by providing the simultaneous and synchronized presentation of visual and audio instructions or media on the ATM. The visual and audio instructions are preferably presented by an ATM display 40 and a speaker or audio port 35 (see FIG. 2). The ATM voice guidance system 100 enables financial services organization to provide ATM machines that can conform, where required, to governing or government regulations, such as the Americans with Disabilities Act, which requires that ATMs be independently usable by the visually and/or hearing impaired.

In Step S10, ATM text instructions or scripts relating to the various functions, operations and capabilities are created. The ATM text instructions or scripts may be modifications of existing ATM scripts or may be original scripts and instructions. These can include among other instructions and scripts: a request for user to enter their personal identification number (PIN), selection of a desired transaction, selecting a user language, a balance inquiry, etc. Further, the ATM scripts may be created in more than one language, e.g., English, Spanish, French, etc. The ATM instructions in the various languages can be useful in ATMs that can be located in consumer markets or locations where a language other than English, such as Spanish, may be advantageous in attracting more ATM users.

In Step S20, the ATM text instructions or scripts are converted into machine or computer readable files and stored. ATM instructions or scripts can be converted into “.wav” audio files using known techniques, products and methods offered by commercial vendors and providers. For example, in one aspect, the ATM instructions and scripts are converted to “.wav” files using a product such as Textaloud MP3 provided by NextUp Technologies, LLC. TextAloud MP3 is text to speech software that uses voice synthesis to create spoken audio from text.

Alternatively, converting the ATM instructions to “.wav” audio files can be accomplished by using a recording microphone, a computer to record input data signals from the microphone, and an appropriate or designated audio conversion software application or program installed and executing on a recording computer. The ATM text instructions can be read out loud and captured by the recording microphone. The recording microphone converts the audible sounds into electronic data signals and transmits them to the recording computer. The recording computer receives the electronic data signals and then coverts the data signals through the designated audio conversion software application, into “.wav” audio files and stores them. As noted previously, the “.wav” audio files can be ATM text instructions or scripts in one or more languages, including English, Spanish, etc., among others.

In Step S30, the stored “.wav” audio files and an associated control software application or program are loaded or downloaded to an ATM intended for use by the visually and/or hearing impaired. As will be described in more detail below with respect to FIG. 2, in one aspect, the “.wav” audio files may be loaded into memory or data storage associated with the ATM. Further, the “.wav” audio files can be loaded to the ATM using voice guidance software applications or programs that, when executed by the processor or controller, provide ATM voice guidance functionality or capability. The ATM instruction or script “.wav” audio files can be loaded to the ATM using techniques, software products and methods offered by commercial vendors and providers. The memory or data storage may be the ATM's internal memory or may be other data storage medium accessible to the ATM processor or controller. Those of ordinary in the art will recognize that the memory can include, random access memory (RAM), read only memory (ROM), programmable ROM, erasable programmable ROM (EPROM), etc., and that data storage can include hard disk, floppy disks, CD-ROM, tape backup systems, etc.

The voice guidance application enables the ATM's processor or controller to access and retrieve selected and specific stored “.wav” audio files and coordinate their playback. The ATM voice guidance system 100 does not permit a user to specifically select any stored “.wav” audio files for playback. Instead, the processor or controller automatically retrieves and plays specific “.wav” audio files associated with displayed instructions or scripts and not in response to a specific user request. During use of the ATM, the retrieved “.wav” audio files are automatically and simultaneously played back in such a manner that they are synchronized with visual or text instructions being displayed on the ATM terminal display screen 40.

The ATM with the voice guidance system 100 provides an ATM machine that permits customers to use and operate the ATM terminal while simultaneously using visual and audio media. In particular, the ATM provides visually and/or hearing impaired customers with the ability to interact with and operate the ATM to carry out financial transactions through the ATM with the stored “.wav” audio files and the displayable ATM instructions or scripts displayed on the ATM display screen. A visually impaired user can interact with and operate the ATM in essentially the same manner as an average or normal user would. However, the ATM voice guidance system 100 provides the additional advantage of simultaneous and automatic playback of“.wav” audio files corresponding to displayed ATM instructions or scripts.

In Step S40, an ATM 5 with the ATM voice guidance system 100 is operable after detection of a user by the ATM. In one aspect, detection of a user and initiation of operation of the ATM is begun when a user inserts their ATM card into the card reader which will read the data stored on the card's magnetic stripe and capture card account information. Those of ordinary skill in the art will readily recognize that the ATM voice guidance system 100 can also be set up to continuously operate by default, i.e., always operating, or may be set up to operate at selected times or under selected criteria. For example, the ATM may prompt the user, both visually and audibly, to select activation of the ATM voice guidance system 100. Alternatively, the ATM may activate the ATM voice guidance system 100 upon reading information and data stored on the user's card that indicate that the user is visually and/or hearing impaired.

In Step S50, the ATM processor and the user interactively communicate so that the user may carry out a desired financial transaction. The ATM voice guidance system enables the ATM processor and the voice guidance system application to access and retrieve appropriate or selected “.wav” audio files for simultaneous and automatic playback of the audio files with corresponding ATM instructions or scripts displayed on the ATM display screen. As discussed previously, the “.wav” audio files correspond to stored text instructions or scripts. Every instruction or script displayed or displayable on the ATM display screen 40 has associated and corresponding “.wav” audio files that has been created and stored in the ATM. Further, every time an instruction or script is displayed on the ATM display screen, a corresponding “.wav” audio file can be automatically accessed and sent to a designated audio port as an output audio signal. Thus, an audio signal corresponding to the displayed instruction or script will always be present at the audio port for the user to connect a listening device, for example, a head set, whether or not the ATM user decides to connect to the audio port.

In Step S60, the ATM processor and voice guidance application deliver operating instructions simultaneously via audio and visual means. In particular, the ATM delivers simultaneous and synchronized instructions via the display screen and the speaker or audio port. A customer can hear the “.wav” audio files via an ATM speaker, a customer headset or an earpiece connected to an audio output port on the ATM. In one aspect, the ATM voice guidance system 100 provides simultaneous playback of “.wav” audio instructions or scripts to users via an audio listening device connected to the audio port in synchronization with corresponding text instructions displayed on the ATM terminal display screen. The user then interactively responds to the ATM instructions by inputting responses and data via the keypad.

FIG. 2 shows an example of a network 200 where the ATM voice guidance system 100 can be implemented. The network or system 200 includes an ATM 5, a host processor 60 and a financial institution network 65. The system 200 also includes communications means that communicatively connect the ATM 5 to the host processor 60 and the host processor 60 to the user's financial institution 65 to a user to carry out an ATM transaction. FIG. 2 shows that the ATM 5 can communicate with the intermediate host system 60 via a dedicated secure communications line 57 or through a secure communications path that uses a publicly available interconnected network, such as the Internet 55. A single dedicated communication path 63 connects the intermediate host processor 60 to the financial institution 65, however more than one secure line may be used or a secure Internet connection may instead be used to communicate. Those of ordinary skill in the art will readily recognize that communications can also be carried out using other means, including, a telephone line and modem, a private communications networks, a satellite communications system, etc.

FIG. 2 shows that the ATM 5 includes a computer processor or CPU 10, an associated memory 15 for data storage and a variety of peripheral ATM input and output devices coupled to the processor 10. The input devices coupled to the processor 10 may include, among others, a card reader 20 and a keypad 25 for data input, and a deposit slot 30 for user submission of materials such as deposit slips and endorsed negotiable instruments. The ATMs may also include output devices coupled to the processor 10, including a speaker and/or audio port 35, a display screen 40, a cash dispenser 45 and a receipt printer 50. The ATM 5 with the voice guidance system can be operated by a user, and particularly a visually and/or hearing user, to carry out transactions, e.g., to retrieve cash from a consumer account, to make deposits or to do a balance inquiry.

The processor 10 preferably controls all functions and operation of the ATM 5 via execution of appropriate program routines and software applications to enable a user to interactively operate the ATM 5. The processor 10, through the execution of machine readable instructions, commands, controls and operates all ATM components and peripheral devices. The routing and processing of input and output data is preferably managed by the ATM processor 10. The processor 10 directs storage and retrieval of data from associated or dedicated memory or data storage components 15. The memory or data storage 15 available to the processor 10 can be dedicated memory storage or other data storage mediums or components such as hard drive memory, disk drive storage, etc.

The card reader 20 preferably accepts a user's card. The ATM 5 may be adapted to accept a specific ATM card or any other type of transaction card, including a charge card, credit card, a bank card, a debit card, a smart card, a stored value card, an electronic card, etc. The card reader 20 and the ATM processor 10 read the data stored on the card's magnetic stripe and capture card account information. The processor 10 uses the captured card account information to send a transaction request to an intermediate host processor 60 which then forwards the transaction request to the cardholder's financial institution or bank 65.

The keypad 25 provides a means for the ATM user to interact with the ATM 5 and to respond to queries presented by the ATM 5 via the display screen 40 and the speaker or audio port 35. For example, the keypad 25 enables a user to enter the user's personal identification number (PIN) when requested by the ATM 5. The PIN can be encrypted to maintain the information secure and confidential. Further, via the keypad 25, a user can enter other data such as the type of transaction being requested, e.g., a cash withdrawal or a balance inquiry, and the amount of the transaction.

The speaker or audio port 35 is adapted to provide the ATM user with audio output instructions or scripts that correspond to the instructions and scripts being displayed on the ATM display screen 40. In one example, the audible ATM operating instructions are generated simultaneously and in synchronization with instructions and information displayed on the ATM display screen 40. The speaker or audio port 35 can also provide auditory feedback, such as a generated “beep signal”, that is outputted to indicate to the ATM user that a key on the keypad 25 has been pressed and recognized. Those of ordinary skill in the art will readily recognize that the speaker and the audio port 35 may be the same component or may be separate physical components on the ATM 5.

As shown, the ATM 5 also has a separate speaker port and an audio port 35 where the user can connect a listening headset. The headset may be the user's personal audio headset or may be provided by the ATM 5 provider. The audio port and headset combination provides operational advantages to the ATM user. The audio port 35 can provide audible output of instructions or scripts synchronized to corresponding instructions and scripts displayed on the ATM display screen 40. This assists visually impaired users who use the audio output to operate the ATM 5 when they cannot read instructions or script on the display screen 40. A user can also use the audible output in conjunction with a headset for listening privacy and to minimize audible interference from external noise sources so that the user can concentrate on the ATM transaction.

The display screen 40, in synchronization with the speaker or audio port 35, interacts with the user through a series of instructions and scripts displayed on display screens during the ATM transaction process. The displayed information may be provided by a monitor that is a monochrome or color cathode ray tube (CRT) display, a monochrome or color liquid crystal display (LCD) or the suitable data display means.

The ATM 5 also has a cash dispenser 45 with a secure currency compartment and a cash-dispensing mechanism. In a cash retrieval transaction, the cash dispenser 45 provides the requested amount of cash to the user. The receipt printer 50 provides the ATM user with tangible proof of the conducted transaction, typically a paper receipt though other media may be used, e.g., receipt data on a floppy disc or CD.

In operation, the ATM 5 connects to and communicates with the intermediate host processor 60 which then provides a communications connection to the ATM network or financial institution network 65 such that the user can carry out an ATM transaction, e.g., cash retrieval, account balance inquiry, etc. The ATM 5 delivers simultaneous and synchronized instructions via the display screen and the speaker or audio port. The user can then interactively responds by entering data on the keypad 25.

Additionally, those of ordinary skill in the art will readily recognize that the functions and capabilities of the ATM 5 and an associated voice guidance system application can be implemented on one or more machines or computers in a network, which may use one or more computer platforms. A general purpose computer may be used to execute computer or machine readable instructions and carryout or perform desired steps or functions. As is known to those of skill in the art, a general-purpose computer typically comprises a central processor, an internal communication bus, various types of memory (RAM, ROM, EEPROM, cache memory, etc.), disk drives or other code and data storage systems, and one or more network interface cards or ports, and sound cards for communication purposes. The computer and computer system may also use a relatively high-speed communication interface to an external network.

Moreover, software functionalities involve programming, including executable code as well as associated stored data. The software code is executable by the general-purpose computer or processor 10 that functions as part of the ATM 5. In operation, the executable program code or software and associated data can be stored in an appropriate memory or data storage 15 location in the ATM 5. The software may also be stored at other locations and/or transported for loading into the appropriate ATM or general-purpose computing machine. In one aspect, the present subject matter involves one or more software products and applications in the form of one or more modules of code carried by at least one machine-readable medium. Execution of such code by a processor of the computer platform or ATM 5 enables the ATM to implement ATM operation, including the voice guidance system application.

As used herein, terms such as computer or machine “readable medium” refer to any medium that participates in providing instructions to a processor for execution. Such a medium may take many forms, including but not limited to, non-volatile media, volatile media, and transmission media. Non-volatile media include, for example, optical or magnetic disks, such as any of the storage devices in a computer or ATM machine. Volatile media include dynamic memory, such as main memory of such a computer. Physical transmission media include coaxial cables, copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include, for example: a floppy disk, a flexible disk, hard disk, magnetic tape, any other magnetic medium, a CD-ROM, DVD, any other optical medium, punch cards, paper tape, any other physical medium with hole patterns, a RAM, a PROM, and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Certain preferred examples have been described and illustrated by way of example only. Those skilled in that art will recognize that the preferred examples may be altered or amended without departing from the inventive spirit and scope of the subject matter. Therefore, the subject matter is not limited to the specific details, representative devices, and illustrated examples in this description. The novel subject matter is limited only by the following claims and equivalents.

We claim:

1. An automated teller machine comprising:
a processor;
a card reader coupled to said processor;
a display screen coupled to said processor;
an audio port coupled to said processor;
a memory means coupled to said processor, said memory means containing instructions which can be output simultaneously to said display screen and said audio port.

2. The automated teller machine of claim 1, wherein said instructions are text files sent to said display screen and corresponding “.wav” files sent to said output port.

3. The automated teller machine of claim 2, further comprising a keypad coupled to said processor and adapted to receive user input.

4. The automated teller machine of claim 3, further comprising a currency dispenser coupled to said processor.

5. The automated teller machine of claim 4, further comprising a deposit receiving means coupled to said processor.

6. The automated teller machine of claim 5, further comprising a transaction receipt means coupled to said processor.

7. The automated teller machine of claim 2, wherein said “.wav” files comprise audio instructions in one of a plurality of languages.

8. A method for providing voice guidance for an automated teller machine, the method comprising the steps of:
a) creating voice guidance instructions;
b) converting said instructions to audio files;
c) loading said audio files to an automated teller machine for subsequent access and retrieval of said audio files for voice guidance;
d) detecting use of said automated teller machine;
e) automatically accessing and retrieving selected audio files and corresponding text instructions; and
f) outputting said selected audio files to an audio port in synchronization with said corresponding text instructions displayed on a display screen.

9. The method of claim 8, wherein the audio files are “.wav” audio files.

10. The method of claim 8, where said audio port can be coupled to a speaker or a headphone set.

11. A computer-readable medium having computer-executable instructions for enabling a user to conduct a transaction on a voice guided automated teller machine, the computer-executable instructions performing the steps of:
a) detecting use of said automated teller machine;
b) verifying an authorized user;
c) automatically accessing and retrieving selected audio files and corresponding text instructions related to operation of said automated tell machine;
d) simultaneously outputting, to said user, text instructions on a display screen and said selected audio files to an audio port to thereby provide audible guidance to said user; and
e) accepting user input to thereby conduct said transaction.

12. The computer-readable medium of claim 11, wherein the step of detecting use of said automated teller machine is initiated by detection of a card in a card reader and reading card information from said card.
